(19) United States
(12) Patent Application Publication
(10) Pub. No.: US 2010/0104484 A1
(43) Pub. Date: Apr. 29, 2010

(54) Hydrogen mixed gas supplying apparatus

(76) Inventor: Hsu-Yang Wang, Taipei City (TW)

Correspondence Address: BACON & THOMAS, PLLC, 625 SLATERS LANE, FOURTH FLOOR, ALEXANDRIA, VA, 22314-1176, US

(21) Appl. No.: 12/318,480

(22) Filed: Dec. 30, 2008

(30) Foreign Application Priority Data
Oct. 29, 2008 (TW) 097141530

(51) Int. Cl. B01J 19/08

(52) U.S. Cl. 422/186.04

(57) ABSTRACT

A hydrogen mixed gas supplying apparatus, consists of: a lead flow pipe, an atomizer, a liquid storage tank and a plasma heater; wherein, the lower end of lead flow pipe is linked to the liquid storage tank through a tube such that the methanol mixed liquid stored in the liquid storage tank is lead into the lead flow pipe; at the bottom end of lead flow pipe is the atomizer that atomizes the methanol mixed liquid into mixed liquid micro particles having average diameter not over 2 μm; lead air from one end of the lead flow pipe pushes the mixed liquid micro particles to plasma heater that dissolved the mixed liquid micro particles into hydrogen ions, hydroxide ions and the corresponding free radicals;and finally, the mixed gas of low temperature hydrogen gas, carbon monoxide, methane, carbon dioxide and nitrogen gas is then generated.

### BACKGROUND OF THE INVENTION

1. Field of the Invention

The present invention relates to a hydrogen mixed gas supplying apparatus, especially to a hydrogen mixed gas supplying apparatus which supplies hydrogen mixed gas without using nozzle and catalyst, while it uses an atomizer to atomize methanol into mixed liquid micro particles having average diameter not over 2 μm, then air is lead to uniformly mix and vaporize said mixed liquid micro particles, at the same time, the mixed liquid micro particles are pushed to a plasma heater, using plasma electron impact into the mixed liquid micro particles, after that, hydrogen ions, the hydroxide ions and the corresponding free radicals are produced, then the hydrogen ions, the hydroxide ions and the corresponding free radicals immediately react with the micro particles of methanol solution, finally, a low temperature mixed gas having hydrogen, carbon monoxide, methane, carbon dioxide and nitrogen, etc., is obtained.

2. Description of Prior Art

It is known to public that hydrogen is an energy and abundantly in nature. However, it is the lightest element and difficult for storage. Therefore, it is compressed and cooled as liquid hydrogen for storage. Because the process for storing hydrogen is very complicated, then the cost for obtaining hydrogen is also very high.

The method for obtaining hydrogen from methanol has been applied by people for years, however, in the process for obtaining hydrogen from methanol, catalyst of Copper (Cu), Chromium (Cr), Manganese (Mn), or oxides of Copper (Cu), Zinc (Zn), Aluminum (Al), etc., is used. Each of said catalysts shall accelerate its aging after the temperature is over 320° C., and the cost shall increase when the reactor is heated by using high pressure or melted liquid of inorganic metal salt. Furthermore, the combustion efficiency of conventional indirect heating process is low and cannot react instantly, the temperature then cannot be stably controlled, it is then very difficult to use hydrogen as the main fuel of engine or combustion apparatus.

The Taiwanese Patent publications related to “fuel cell” are as follows:

Taiwan Patent Publication No. 503191 entitled: “Four Wheeled Fuel Cell Automobile”; Taiwan Patent Publication No. 496376 entitled: “Hydrogen Storage Apparatus For Fuel Cell Of Electric Bicycle”; and Taiwan Patent Publication No. 476333 entitled: “The Construction Of Electric Bicycle By Using Fuel Cell As Energy System”. However, the main construction for generating the fuel-hydrogen for conventional fuel cell is a reformer mainly using a fuel tank for storing liquid fuel, and a nozzle to atomize the fuel, the liquid fuel is then further vaporized after been heated by a heater inside the reformer, the vaporized fuel then is converted to hydrogen rich gas and carbon dioxide via the conversion of a catalyst converter, wherein the hydrogen can be finally provided to the anode of fuel cell and generates an electric-chemical reaction with the oxygen in the air of cathode to produce electric energy, and said electric energy can be stored in a supplementary cell for storing the electric power produced by the fuel cell.

However, in the process of conversion, in order to make the converted hydrogen be effective, the liquid fuel has to be uniformly heated by the reformer. If the temperature generated by heating cannot be uniform and the extra energy for heating has to be provided, the heating efficiency then cannot be satisfactory. In addition, the energy may be wasted because the complete heating and vaporization cannot be achieved.

The Taiwanese Patent Publication No M246204 entitled: “Carbon-hydrogen fuel reformer having the function of automatical switching the operation module” provides a reformer having a heating channel respectively connecting a heating plug, an air supply system, a fuel supply system and a vapor supply system, and a control module having temperature sensor to sense the temperature change at the outlet of catalyst layer inside the reformer, then to respectively control the operations of said heating plug, said air supply system, said fuel supply system and said vapor supply system, and then automatically adjust the different reform models.

Nevertheless, the above models for generating hydrogen by using reformer have the following disadvantages: that is, the heating not only cannot be uniformly maintained, the atomized particles exhausted from nozzle is still large in size, it is then has to use the high temperature plasma heater for heating, while the high temperature heating may not only result carbon deposit, the methanol particles heated by high temperature heater also have to be reacted by catalyst, then the effect of hydrogen mixed gas is not satisfactory for application, the cost for generating hydrogen is high, the apparatus for generating hydrogen is large and complicated.

In view of the disadvantages found in conventional reformer for generating hydrogen mixed gas, the inventor has dedicated great efforts studying various approaches against the above mentioned deficiencies; after continuously researching and experimenting, the inventor ultimately brings about the formulation and design of the present invention.

### SUMMARY OF THE INVENTION

The main object of present invention is to provide a hydrogen mixed gas supplying apparatus which uses an atomizer to atomize methanol into mixed liquid micro particles having average diameter not over 2 μm, such that the mixed liquid micro particles floatedly flow in a pipe, then air is lead to uniformly mix and vaporize said mixed liquid micro particles into a higher temperature oxidized mixed fluid micro particles, afterwards, a low temperature plasma heater is used to dissolve said oxidized mixed liquid micro particles in a temperature between 180° C.-230° C. by using plasma electron impact into the mixed liquid micro particles, after that, hydrogen ions, the hydroxide ions and the corresponding free radicals are produced, then the hydrogen ions, the hydroxide ions and the corresponding free radicals immediately react with the micro particles of methanol solution, accordingly, a low temperature mixed gas having hydrogen, carbon monoxide, methane, carbon dioxide and nitrogen etc., is obtained.

According to the hydrogen mixed gas supplying apparatus of present invention, the average diameters of the mixed liquid micro particles can be further controlled not over 2 μm and even much smaller, the generation speed for hydrogen mixed gas can be increased, and because the temperature for providing hydrogen mixed gas can be maintained in 15° C.-25° C., the generated hydrogen mixed gas can be directly lead into gasoline engine or diesel engine for uses, this is a second object of present invention.

According to the hydrogen mixed gas supplying apparatus of present invention, it not only can stably and rapidly generate hydrogen mixed gas, while the construction of apparatus is simple and the waste of electricity is low, this is another object of present invention.

According to the hydrogen mixed gas supplying apparatus of present invention, the hydrogen mixed gas is generated without using nozzle and catalyst, the dimension of the whole construction is greatly reduced, the cost then is also greatly reduced, this is a further object of present invention.

A more complete understanding of these and other features and advantages of the present invention will become apparent from a careful consideration of the following detailed description of certain embodiments illustrated in the accompanying drawings.

### BRIEF DESCRIPTION OF THE DRAWINGS

FIG. 1 is a plane view showing the system of present invention.

FIG. 2 is a cross-sectional view showing the lead flow pipe of present invention.

FIG. 3A is a plane view showing the lead flow elements of present invention.

FIG. 3B is a bottom view showing the lead flow elements of present invention.

FIG. 3C is a side view showing the lead flow elements of present invention.

FIG. 4 is a cross-sectional view showing the function of present invention.

FIG. 5 is an electric circuit showing the heater used in the present invention.

FIG. 6 is a plane view showing the another embodiment of present invention.

### DETAILED DESCRIPTION OF THE PREFERRED EMBODIMENTS

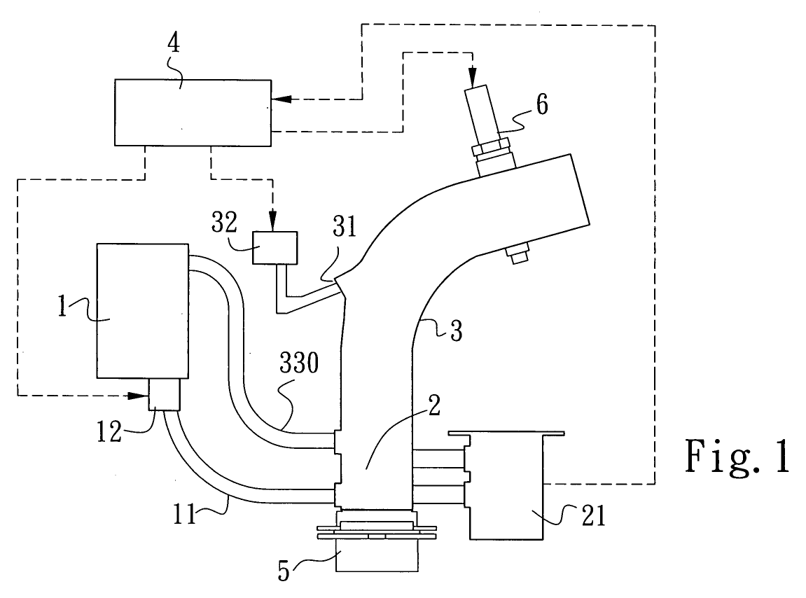

An shown in FIG. 1, the hydrogen mixed gas supplying apparatus of present invention comprises a liquid storage tank 1, a reaction device 2, a lead flow pipe 3, a controller 4, an atomizer 5 and a plasma heater 6; wherein, the inner space of said liquid storage tank 1 is used for storing liquid mixture having methanol as main component, one end of the liquid storage tank 1 is connected with a guide tube 11 to transport the methanol mixed liquid to the reaction device 2, on the passageway of guide tube 11, an one-way valve 12 is installed, the open and close of said one-way valve 12 is controlled by a controller 4, so as to control the flow quantity of said methanol mixed liquid.

Said reaction device 2 is installed at the lower end inside said lead flow pipe 3, one end of the reaction device 2 is a liquid level sensor 21, one end of the liquid level sensor 21 is connected to said controller 4; when the liquid level of the methanol mixed liquid is lower then the quantity pre-determined, the liquid level sensor sends a signal to the controller 4, the controller then opens the one-way valve 12 to input the methanol mixed liquid to the reaction device 2; the lower end of said reaction device 2 is installed with an atomizer 5, which can be ultrasonic atomizer or piezoelectric oscillate atomizer and, which oscillates and atomizes the methanol mixed liquid flowing into the reaction device 2, such that the methanol mixed liquid is atomized into methanol mixed liquid micro particles having diameter smaller than 2 μm. In this stage, the methanol mixed liquid micro particles shall be naturally floated and flowing upward along the passageway of the lead flow pipe 3 without assistance of external forces.

Referring again to FIG. 1, an air inlet 31 is formed at the flowing passageway of the lead flow pipe 3, said air inlet 31 is installed mainly for introducing air to vaporize the passing methanol mixed liquid micro particles and keep the liquid micro particles at a pre-determined temperature (about 80° C.), at that instant, the methanol mixed liquid micro particles are pushed by the introduced air to heating area, while the amount of air flowing into the lead flow pipe 3 is controlled by an air inlet pump 32 via said controller 4.

As shown in FIG. 1, a plasma heater 6 is installed near the outlet of said lead flow pipe 3, said plasma heater 6 is preferably a plug which generates slice shape plasma electric arc, and which is mainly a low temperature plasma heater. Consequently, by the plasma electric arc generated by plug, the methanol mixed liquid micro particles shall be heated to pyrolysis, and the hydrogen mixed gas is obtained. The temperature of heating area is controlled to be kept between 180° C.-230° C., by doing so, the hydrogen mixed gas generated via the heating to pyrolysis of the methanol mixed liquid micro particles by plasma heater 6 can be kept in a temperature of 15° C.-25° C.

The plasma heater 6 is functioned to plasma electron impact said methanol mixed liquid micro particles and dissociate the liquid micro particles into hydrogen ions, hydroxide ions and the corresponding free radicals; after the hydrogen ions, the hydroxide ions and the corresponding free radicals are formed, they immediately react with the undissolved methanol mixed liquid micro particles, such that rapidly generate a great quantity of hydrogen (H₂), carbon monoxide (CO), carbon dioxide (CO₂) and methane with the temperature to be kept between 15° C.-25° C.

Because the temperature of the hydrogen mixed gas generated by the hydrogen mixed gas supplying apparatus of present invention is about 15° C.-25° C., it is not necessary to lower or rise the temperature of hydrogen mixed gas, and the hydrogen mixed gas can be directly conducted into intake manifold of engine or other combustion apparatus for practical applications.

The said methanol mixed liquid can be pure methanol or methanol solution mixed with water or other liquid solutions in a pre-determined ratios.

The said atomizer 5 can be one made with self-activated circuit or separate-excitation circuit, yet atomizer using separate-excitation circuit consumes less electricity.

The plug used by the plasma heater 6 comprises of positive electrode and negative electrode, a heating area is formed between the positive electrode and negative electrode and can generate electric arc, since the heating area is maintained at the temperature between 180° C.-230° C., the accumulation of carbon at the heating end can be avoided, in addition, because the plasma heater 6 uses low temperature plasma heater, the electricity consumed is low and its source of electricity can then be drawn directly from the battery of an automobile or electric bicycle.

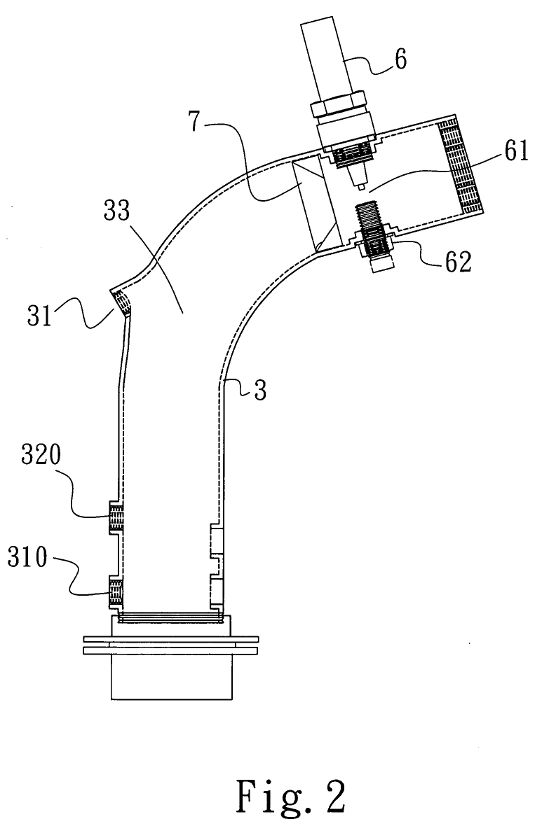

Please refer to FIG. 2, the lead flow pipe 3 of the hydrogen mixed gas supplying apparatus of present invention has a section of curve pipe, the curved portion is a slow impact segment 33, near which is installed an air inlet 31 which atomizes the methanol mixed liquid into methanol mixed liquid micro particles having average diameter not over 2 μm, the micro particles is then converged together when it floats and flows up to the slow impact segment 33 along the lead flow pipe 3, at the same time, by leading in air from the air inlet 31, both the mixed liquid micro particles and the air are then uniformly mixed, vaporized and heated. Also, because the air inlet 31 is installed at the curved section of lead flow pipe, the lead-in air then simultaneously pushes the mixed liquid micro particles to flow towards the plasma heater 6.

As shown in FIG. 2, at the lower end of the lead flow pipe 3, not only an aperture 310 for leading in the methanol mixed liquid, but also has an air outlet 320 that connects to the liquid storage tank 1 by a lead pipe 330 (as shown in FIG. 1) is formed, such construction promotes the flowing of the methanol mixed liquid.

The heating area 61 of the plasma heater 6 that generates electric arc is installed at the center line of the lead flow pipe, the top of the plasma heater 6 is the anode while its cathode links to a copper pillar 62, near the plasma heater 6 inside the lead flow pipe 3 is a lead flow component 7.

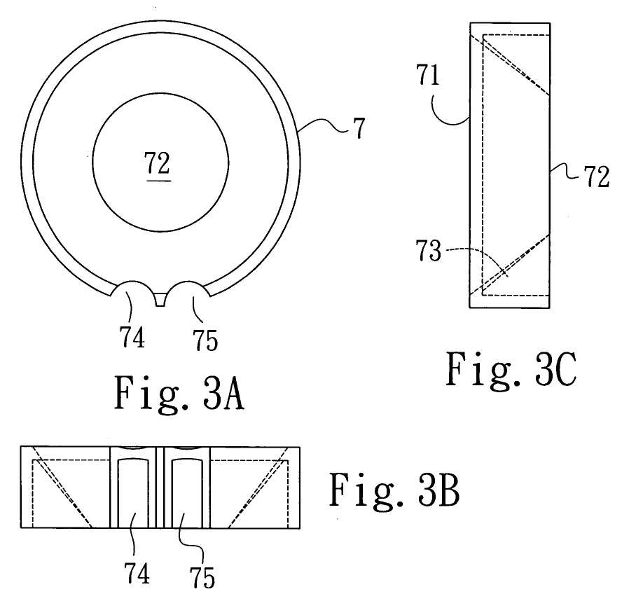

Please refer to FIGS. 3A, 3B and 3C, the said lead flow component 7 has an air inlet 71 formed near the atomizer 5 and an air outlet 72 near the plasma heater 6, the air inlet 71 is bigger in size than the air outlet 72, a lead flow paddle 73 is formed between air inlet 71 and air outlet 72; the lead flow component 7 can collect the methanol mixed liquid micro particles that have been vaporized and heated by air and lead flow to the heating area 61 of plasma heater 6, such that the electron group of electric arc of the plasma heater 6 can impact and dissolve the mixed liquid micro particles by electron. At the low end of the lead flow component 7 is two return outlets 74, 75 which return the unheated mixed liquid micro particles to the reaction device 2 when the mixed liquid micro particles is turned to liquid phase, and then atomizes the liquid particles by the atomizer.

The hydrogen mixed gas supplying apparatus of present invention can use control device such as chip card, computer system or other sensors to allow only certain operator to open the liquid storage tank for adding liquid in order to avoid the liquid storage tank being accidentally opened or added with other liquid, such that it is safe to be used.

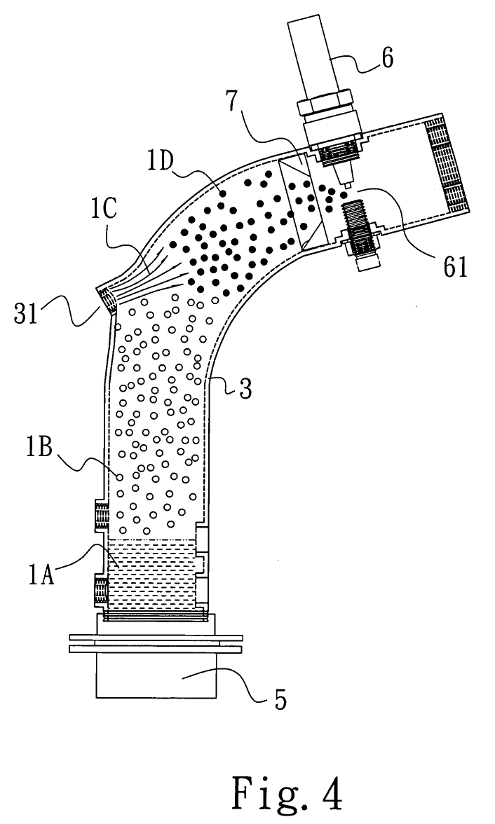

The hydrogen mixed gas supplying apparatus of present invention can be as shown in FIG. 4 that, after the methanol mixed liquid 1A is lead into reaction device, atomizer 5 atomizes the methanol mixed liquid into mixed liquid micro particles 1B having average diameter not over 2 μm, the said mixed liquid micro particles 1B is then naturally floated and flowing upward along the lead flow pipe 3 without the assistance of external force; when the said mixed liquid micro particles 1B floats and flows near air inlet 31, its flowing speed is slowed down and it is gathered at the curved section of slow impact segment, and then air 1C is introduced to fully and uniformly mix, vaporize and heat the mixed liquid micro particles 1B and the air 1C into oxidized micro particles 1D, at the same time, the introduced air pushes oxidized micro particles ID to plasma heater 6, the oxidized micro particles ID is then collected and flow to the heating area 61 of plasma heater 6 via lead flow component 7 for heating and pyrolysis, after the heating and pyrolysis, oxidized micro particles ID is dissociated into hydrogen ions, hydroxide ions and the corresponding free radicals, they immediately react with the surrounding non-pyrolized oxidized micro particles to rapidly form the mixed gas of hydrogen (H₂), carbon monoxide (CO), carbon dioxide (CO₂) and methane (CH₄) of temperature between 15° C.-25° C.

The said atomizer is to atomize methanol mixed liquid into mixed liquid micro particles having average diameter less than 2 μm, but due to the property and function of atomizer, micro particles atomized at different position has different diameter, the smaller the diameter (for example, 0.8 μm-1.5 μm or even smaller), the mixed liquid micro particles becomes easier to float and flow upward, and when the micro particles of larger diameter cannot float up, they drop down inside the lead flow pipe and being atomized again. Therefore, the micro particles' average diameter being less than 2 μm is not a restriction for present invention, it only means that the atomized micro particles has diameter not over 2 μm.

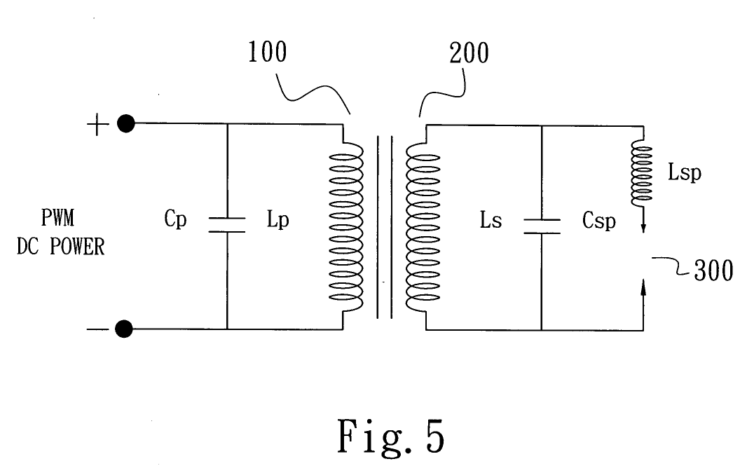

The hydrogen mixed gas supplying apparatus of present invention, as shown in FIG. 5, the plasma heater 6 is for:
1. By the first coil 100 and the second coil 200, a step-up transformer of low electric resistance and low inductance is matched to a plug of no electric resistance to make up output electrode of plasma, which significantly increases the flux of electricity.
2. Use a low voltage capacitor Cp of microfarad for storing energy power to provide electricity to the first coil for a short time.
3. Use a high voltage capacitor Csp of picofarad (pF) to nanofarad (nF) among 20KV-500KV for storing high voltage energy to provide instant and large quantity of energy to plasma.
4. Use Pulse Width Modulation for generating direct current to supply electricity to the demand of first coil, this can reduce waste of electricity and so reduce the total amount of consumption.
5. The plasma heating area 300 is maintained at the temperature between 180° C.-230° C., it uses plurality of receiver electrodes to match with the electrodes which emitting electron group of plasma so to increase the area of reaction and further increases the efficiency of reaction. For example, two or more receiver electrodes, or round electrode receiver in alternative can be used in the heating area.

Therefore, the hydrogen mixed gas supplying apparatus of present invention uses low temperature plasma heater to heat and separate the methanol mixed liquid micro particles that entered the heating area into hydrogen ions, hydroxide ions and the corresponding free radicals; after the hydrogen ions, the hydroxide ions and the corresponding free radicals are formed, they react with the undissolved methanol mixed liquid micro particles, such that a low temperature hydrogen mixed gas with the temperature kept between 15° C.-25° C. is generated. The reaction formulas are as follow:

CH₃OH→CH₃+OH (1)

CH₃OH→CH₂HO+H (2)

CH₃OH→CH₃O+H (3)

CH₃+H→CH₄ (4)

H+H→H₂ (5)

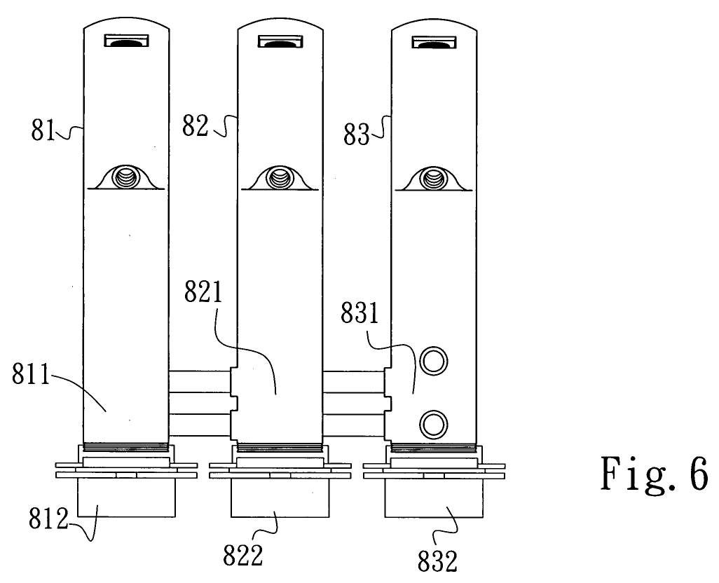

Please refer to FIG. 6, the hydrogen mixed gas supplying apparatus of present invention can combine plurality of lead flow pipes 81, 82, 83 into an array, each reaction device 811, 821, 831 of the lead flow pipe 81, 82, 83 is the same and each lead flow pipe uses the liquid level sensor in their own group to control the liquid level of the methanol mixed liquid inside the reaction device, at the lower end of each lead flow pipe 81, 82, 83 has an atomizer 812, 822, 832 and is heated by a plasma heater, by such construction, multiple quantity of hydrogen mixed gas is then produced.

After the testing of experimentation, hydrogen mixed gas supplying apparatus of present invention has the following result data:

### [Experiment 1]

When implementing the hydrogen mixed gas supplying apparatus of present invention, if the generated amount of hydrogen mixed gas is to be 11 Liter/minute, its electricity consumption amount is 63 W; and wherein:
Hydrogen gas (H₂): 1.76 Liter/minute
Carbon monoxide (CO): 1.82 Liter/minute
Carbon dioxide (CO₂): 0.48 Liter/minute
Methane (CH₄): 0.015 Liter/minute
Rests are Nitrogen gas (N₂) and Oxygen gas (O₂)

### [Experiment 2]

When implementing the hydrogen mixed gas supplying apparatus of present invention, if the generated amount of hydrogen mixed gas is to be 50 Liter/minute, its electricity consumption amount is 255 W, wherein:
Hydrogen gas (H₂): 7.15 Liter/minute
Carbon monoxide (CO): 6.5 Liter/minute
Carbon dioxide (CO₂): 4.25 Liter/minute
Methane (CH₄): 0.45 Liter/minute
Rests are Nitrogen gas (N₂) and Oxygen gas (O₂)

In conclusion from the above, the hydrogen mixed gas supplying apparatus of present invention supplies hydrogen mixed gas without using nozzle and catalyst, while it uses an atomizer to atomize methanol into mixed liquid micro particles having average diameter not over 2 μm, based on the micro particles' property to naturally float up inside the lead flow pipe, the mixed liquid micro particles are then vaporized and pushed by air, and then dissolved by the plasma heater with low heat, such that a mixed gas of hydrogen, carbon monoxide, methane, carbon dioxide and nitrogen with the temperature between 15° C.-25° C. are rapidly generated. Because the mixed gas supplying apparatus is small in size with simple construction, its cost is greatly reduced. And, such low temperature hydrogen mixed gas can be applied to engines directly, it does make up the deficiency of conventional reformer. Since the hydrogen mixed gas supplying apparatus of present invention has never been disclosed to public before, and its unique character and ability are more advanced, it is then believed that the present invention is an invention with progressiveness, and meets the requirement of patent application according to the Patent Law.

Although the present invention has been described with a certain degree of particularity, the present disclosure has been made by way of example and changes in details of structure may be made without departing from the spirit thereof.

What is claimed is:

1. A hydrogen mixed gas supplying apparatus, comprises of:
an atomizer, for atomizing methanol mixed liquid into mixed liquid micro particles having average diameter not over 2 μm;
a lead flow pipe, for said atomized mixed liquid micro particles that have average diameter not over 2 μm to float and flow in the pipe; and
a plasma heater, to heat dissolving the mixed liquid micro particles that have entered into its heating area into hydrogen ions, hydroxide ions and the corresponding free radicals;
wherein after the said hydrogen ions, hydroxide ions and the corresponding free radicals are formed, they immediately react with the uncraked mixed liquid micro particles, the low temperature hydrogen mixed gas is then generated.

2. A hydrogen mixed gas supplying apparatus as claimed in claim 1, wherein the said plasma heater is a low temperature plasma heater.

3. A hydrogen mixed gas supplying apparatus as claimed in claim 1, wherein the heating area of the said plasma heater has a temperature between 180° C.-230° C.

4. A hydrogen mixed gas supplying apparatus as claimed in claim 3, wherein the low temperature hydrogen mixed gas that is generated after heat pyrolysis of methanol mixed liquid by the plasma heater has a temperature between 15° C.-25° C.

5. A hydrogen mixed gas supplying apparatus as claimed in claim 1, wherein an air inlet is formed at one end of the said lead flow pipe, the air inlet leads in air to fully mix and vaporize with mixed liquid micro particles and push the mixed liquid micro particles to flow towards the plasma heater.

6. A hydrogen mixed gas supplying apparatus as claimed in claim 5, wherein the said lead flow pipe has a slow impact segment at the air inlet, the slow impact segment is a curved passage that allows mixed liquid micro particles to fully mix with the air lead from the air inlet.

7. A hydrogen mixed gas supplying apparatus as claimed in claim 6, wherein a reaction device is installed at the lower end of the said lead flow pipe, and an atomizer is installed at the lower end of the reaction device, the reaction device is connected to a liquid storage tank that stores methanol mixed liquid via a lead pipe.

8. A hydrogen mixed gas supplying apparatus as claimed in claim 7, wherein a liquid level sensor is installed at one end of the said reaction device.

9. A hydrogen mixed gas supplying apparatus as claimed in claim 8, wherein inside the said lead flow pipe is a lead flow component that leads the vaporized and heated mixed liquid micro particles to the heating area of the plasma heater.

10. A hydrogen mixed gas supplying apparatus as claimed in claim 9, wherein a return outlet is formed at the lower end of the said lead flow component to allow the mixed liquid micro particles that are not heated by the plasma heater to flow back to the reaction device when the mixed liquid micro particles are turned into liquid form, and then be atomized again for use.

11. A hydrogen mixed gas supplying apparatus as claimed in claim 10, wherein the said lead flow pipe is formed by multiple components.

12. A hydrogen mixed gas supplying apparatus as claimed in claim 7, wherein a control switch is installed at the said liquid storage tank to make sure the tank shall not be opened at random.

13. A hydrogen mixed gas supplying apparatus as claimed in claim 12, wherein the said control switch of liquid storage tank is controlled by a chip card.

14. A hydrogen mixed gas supplying apparatus as claimed in claim 1, wherein the said low temperature plasma heater is formed by a plug associating with a high voltage capacitor.

15. A hydrogen mixed gas supplying apparatus as claimed in claim 14, wherein the said low temperature plasma heater uses the first coil and the second coil to match step-up transformer of low resistance and low inductance to the plug of no resistance as plasma output electrode for increase the current.

16. A hydrogen mixed gas supplying apparatus as claimed in claim 15, wherein the said low temperature plasma heater uses a microfarad low voltage capacitor for storing energy power to provide electricity to the first coil for a short time.

17. A hydrogen mixed gas supplying apparatus as claimed in claim 16, wherein the said low temperature plasma heater uses Pulse Width Modulation for generate direct current to supply electricity to the demand of first coil, this can reduce waste of electricity and so reduce the total amount of electricity consumption.

18. A hydrogen mixed gas supplying apparatus as claimed in claim 17, wherein the said low temperature plasma heater uses high voltage capacitor of picofarad (pF) to nanofarad (nF) among 20 KV-500 KV.

19. A hydrogen mixed gas supplying apparatus as claimed in claim 18, wherein the said low temperature plasma heater uses the plug of almost no resistance.

20. A hydrogen mixed gas supplying apparatus as claimed in claim 1, wherein the average diameter of the said mixed liquid micro particles is 0.8 μm-1.5 μm, or even smaller.

21. A hydrogen mixed gas supplying apparatus as claimed in claim 1, wherein the said atomizer can be ultrasonic atomizer or piezoelectric oscillate atomizer, and preferably, atomizer made with separate-excitation circuit.

22. A hydrogen mixed gas supplying apparatus as claimed in claim 1, wherein the said hydrogen mixed gas comprises of hydrogen gas (H₂), carbon monoxide (CO), carbon dioxide (CO₂) and methane (CH₄).

23. A hydrogen mixed gas supplying apparatus as claimed in claim 1, wherein it consists a controller to control the operation of the atomizer and the plasma heater.
